(19) United States
(12) Patent Application Publication
(10) Pub. No.: US 2012/0299248 A1
(43) Pub. Date: Nov. 29, 2012

(54) Shaft sealing ring for a barrier oil sealing system of a hydrogen-cooled generator

(76) Inventors: Christopher Cordiner, Ashington (GB); Thomas Günther, Meerbusch (DE); Christoph Lehmann, Neukirchen-Vluyn (DE); Oliver Majchrzak, Oberhausen (DE)

(21) Appl. No.: 13/477,190

(22) Filed: May 22, 2012

(30) Foreign Application Priority Data
May 26, 2011 (EP) EP11167707

(51) Int. Cl. F16J 15/40

(52) U.S. Cl. 277/409

(57) ABSTRACT

A shaft sealing ring for a barrier oil sealing system of a hydrogen-cooled generator is designed, in the installed state, to bear radially against a generator shaft by way of its running surface arranged on the inner side and to interact with the generator shaft, under the action of a barrier oil, with hydrogen sealing, wherein the shaft sealing ring is produced from a lead bronze material.

### CROSS REFERENCE TO RELATED APPLICATIONS

This application claims priority of European Patent Office application No. 11167707.6 EP filed May 26, 2011. All of the applications are incorporated by reference herein in their entirety.

### FIELD OF INVENTION

A shaft sealing ring for a barrier oil sealing system of a hydrogen-cooled generator is provided, in the installed state, to bear radially against a generator shaft by way of its running surface arranged on the inner side and to interact with the generator shaft, under the action of a barrier oil, with hydrogen sealing, characterized in that the shaft sealing ring is produced from a lead bronze material.

### BACKGROUND OF INVENTION

A rotating electrical machine, for example a motor or a generator, has a shaft for transmitting a torque. Heat released during operation of the electrical machine, in particular the heat released at the shaft, is dissipated by way of a cooling circuit. In this case, air, water or hydrogen is used in the cooling circuit as a carrier medium for the heat. The advantages of hydrogen over air and water lie in a higher heat absorption capacity and in lower frictional losses. In order to prevent hydrogen from escaping from the cooling circuit, use is made of a barrier oil sealing system on the shaft. The barrier oil sealing system comprises a shaft sealing ring, with a sealing gap being formed between the inner side of the shaft sealing ring and the shaft. A circumferential furrow is provided in the inner side of the shaft sealing ring, via which circumferential furrow a barrier oil is made to flow into the sealing gap. Feed lines for the barrier oil are located on the end faces or on the outer side of the shaft sealing ring.

The material of the shaft sealing ring is selected with regard to its strength and its sliding behavior with the shaft. In the event that the shaft sealing ring brushes against the shaft in what is known as an emergency running situation, the demands made on the material are such that damage must not occur on the surface of the shaft sealing ring or the surface of the shaft. Damage to the surface of the shaft sealing ring or of the shaft can lead to leakage and thus to the escape of hydrogen from the cooling circuit. One design of the shaft sealing ring consists in the use of bronze, with the sealing ring being manufactured in one piece from a bronze workpiece. If the shaft sealing ring made of bronze is used, however, the surface of the shaft can disadvantageously be damaged in emergency running situations.

One alternative to the use of bronze is the use of white metal, which is distinguished by better sliding behavior with the shaft. However, white metal has a low strength, and therefore use is made of an annular supporting body which is made of steel or bronze and is provided with a layer of white metal. The layer of white metal is applied to the inner side of the supporting body in this case by way of a centrifugal casting process. In order to achieve a good bond between the white metal and the supporting body, the supporting body is provided with a layer of tin before the layer of white metal is applied. However, bonding defects between the white metal and the supporting body can disadvantageously arise. Furthermore, the layer of white metal may be damaged in emergency running situations as a result of high temperatures or of other fatigue phenomena.

SUMMARY OF INVENTION

It is an object of the invention to provide a shaft sealing ring for a barrier oil sealing apparatus of a hydrogen-cooled generator, with the shaft sealing ring having good emergency running properties.

The shaft sealing ring according to the invention for a barrier oil sealing system of a hydrogen-cooled generator is designed, in the installed state, to bear radially against a generator shaft by way of its running surface arranged on the inner side and to interact with the generator shaft, under the action of a barrier oil, with hydrogen sealing, characterized in that the shaft sealing ring is produced from a lead bronze material. When the shaft sealing ring according to the invention is provided in the barrier oil sealing system, the good sliding behavior of said shaft sealing ring with the generator shaft means that, in emergency running situations, advantageously no damage occurs on the surface of the shaft sealing ring or on the surface of the generator shaft. This results in a longer service life of the shaft sealing ring. Furthermore, the high strength of the lead bronze material means that the shaft sealing ring can advantageously be produced from a workpiece in one piece. This renders the complex application of a layer of metal superfluous, as a result of which no bonding defects can arise and a reduction in costs is obtained. Furthermore, ultrasonic testing following production of the shaft sealing ring is no longer required.

The lead bronze material preferably comprises between 10% by mass and 20% by mass lead. It is preferable for at least one circumferential furrow to be provided in the running surface, via which circumferential furrow the barrier oil can flow to the generator shaft and as a result of which at least two running surface portions are formed.

A plurality of axially extending lubricating grooves are preferably provided distributed over the circumference in at least one of the running surface portions and each issue into the circumferential furrow. By virtue of the lubricating grooves, an increased flow of barrier oil and a more uniform distribution of the barrier oil at the running surface are advantageously achieved. The temperature at the running surface is thereby advantageously reduced, as a result of which the viscosity of the barrier oil increases. As a result of the increase in viscosity, the shaft sealing ring advantageously brushes against the generator shaft less frequently, as a result of which damage to the surface of the shaft sealing ring and of the generator shaft is reduced.

The axial extension of each lubricating groove preferably amounts to between 20% and 80% of the width of the running surface portion in which it is provided. Furthermore, the depth of each lubricating groove preferably amounts to between 0.5 mm and the depth of the circumferential furrow. In addition, the extension of each lubricating groove in the circumferential direction is preferably at most as long as the axial extension thereof.

The lubricating grooves preferably each have a rectangular outline. Alternatively, the circumferential cross sections of the lubricating grooves preferably taper proceeding from the circumferential furrow.

One group of the lubricating grooves is preferably arranged on the running surface portion on the atmosphere side. It is preferable for another group of the lubricating grooves to be arranged on the running surface portion on the hydrogen side. Furthermore, it is preferable for at least eight lubricating grooves distributed uniformly over the circumference to be provided.

### BRIEF DESCRIPTION OF THE DRAWINGS

The invention is explained hereinbelow on the basis of preferred embodiments of the shaft sealing ring according to the invention and with reference to the appended schematic drawings, in which:

FIG. 1 shows a perspective view of a first embodiment of the shaft sealing ring according to the invention, and

FIG. 2 shows a cross section of a second embodiment of the shaft sealing ring according to the invention.

### DETAILED DESCRIPTION OF INVENTION

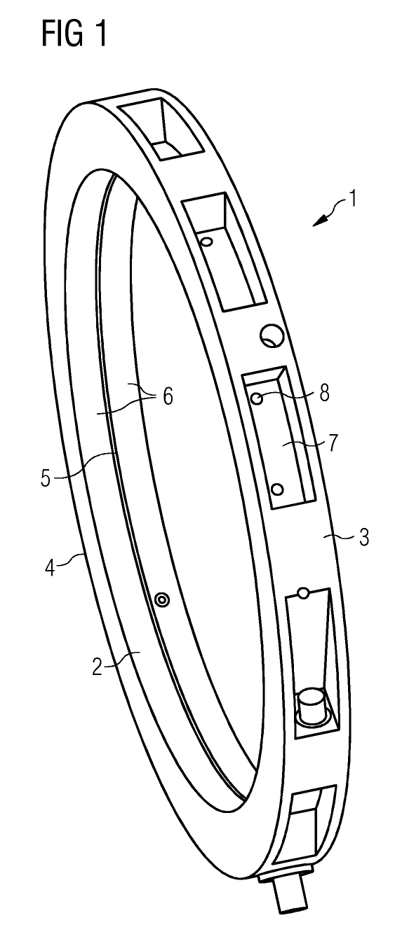

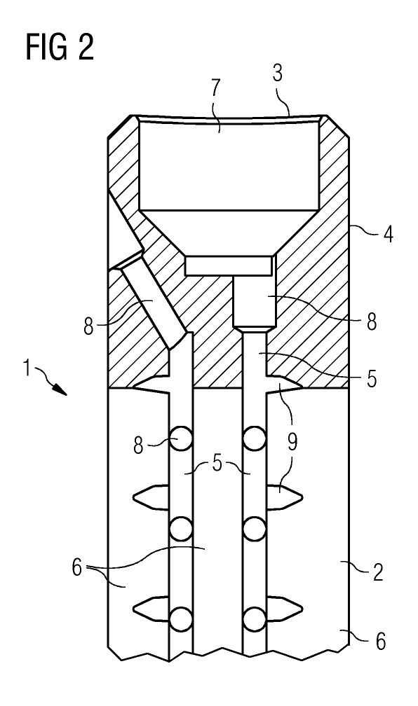

As can be seen in FIGS. 1 and 2, a shaft sealing ring 1 has an inner face 2, an outer face 3 and two end faces 4. The shaft sealing ring 1 is produced from a lead bronze material which comprises between 10% by mass and 20% by mass lead. A plurality of cutouts 7, in which oil inflow holes 8 are made, are provided in the outer face 3.

In the first embodiment, the shaft sealing ring 1 as shown in FIG. 1 has a circumferential furrow 5 provided in the inner face 2. Two running surface portions 6 extend from the circumferential furrow 5 as far as the outer edge of the shaft sealing ring 1. The oil inflow holes 8 extend from the cutouts into the circumferential furrow 5.

In contrast to the first embodiment, the second embodiment as shown in FIG. 2 has two circumferential furrows 5 in the inner face 2. As a result, three running surface portions 6 are formed, specifically two portions lying on the outside, which extend from the circumferential furrows 5 as far as the end faces 4, and a portion lying on the inside, which extends between the two circumferential furrows 5. At least eight lubricating grooves 9 are provided in each of the two outer running surface portions 6 and each issue into the circumferential furrows 5. The circumferential cross sections of the lubricating grooves 9 taper proceeding from the circumferential furrows 5. In the axial direction, the lubricating grooves 9 extend to a length which corresponds approximately to 60% of the width of the running surface portion 6 in which they are provided. The depth of the lubricating grooves 9 amounts to about 25% of the depth of the circumferential furrows 5. The extension of the lubricating grooves 9 in the circumferential direction amounts to about 75% of the axial extension thereof. FIG. 2 shows two oil inflow holes 8, with the oil inflow hole 8 on the right-hand side proceeding from one of the cutouts 7, running parallel to the end faces 4 and issuing into the circumferential furrow 5 on the right-hand side. The oil inflow hole 8 on the left-hand side proceeds from the end face 4 on the left-hand side, runs at an angle with respect thereto and issues into the circumferential furrow 5 on the right-hand side.

Embodiments in which the lubricating grooves 9 are introduced either only in the running surface portion 6 on the hydrogen side or only in the running surface portion 6 on the atmosphere side are similarly conceivable. Furthermore, lubricating grooves 9 with rectangular outlines are conceivable. Similarly, it is conceivable that, in the case of an embodiment with lubricating grooves in the running surface portion on the hydrogen side and in the running surface portion on the atmosphere side, the lubricating grooves are arranged offset with respect to one another.

While specific embodiments have been described in detail, those with ordinary skill in the art will appreciate that various modifications and alternative to those details could be developed in light of the overall teachings of the disclosure. Accordingly, the particular arrangements disclosed are meant to be illustrative only and not limiting as to the scope of the invention, which is to be given the full breadth of the appended claims, and any and all equivalents thereof.

We claim:

1. A shaft sealing ring for a barrier oil sealing system of a hydrogen-cooled generator, comprising:
a shaft sealing ring comprising a lead bronze material,
wherein the shaft sealing ring is designed, in the installed state, to bear radially against a generator shaft by way of its running surface arranged on the inner side and to interact with the generator shaft, under the action of a barrier oil, with hydrogen sealing.

2. The shaft sealing ring as claimed in claim 1, wherein the lead bronze material comprises between 10% by mass and 20% by mass lead.

3. The shaft sealing ring as claimed in claim 1, wherein a circumferential furrow is provided in the running surface, via which circumferential furrow the barrier oil may flow to the generator shaft and as a result of which at least two running surface portions are formed.

4. The shaft sealing ring as claimed in claim 3, wherein a plurality of axially extending lubricating grooves are provided distributed over the circumference in at least one of the running surface portions and each issue into the circumferential furrow.

5. The shaft sealing ring as claimed in claim 4, wherein the axial extension of each lubricating groove amounts to between 20% and 80% of the width of the running surface portion in which it is provided.

6. The shaft sealing ring as claimed in claim 4, wherein the depth of each lubricating groove amounts to between 0.5 mm and the depth of the circumferential furrow.

7. The shaft sealing ring as claimed in one of claims 4, wherein the extension of each lubricating groove in the circumferential direction is at most as long as the axial extension thereof.

8. The shaft sealing ring as claimed in claim 4, wherein the lubricating grooves each have a rectangular outline.

9. The shaft sealing ring as claimed in claim 4, wherein the circumferential cross sections of the lubricating grooves taper proceeding from the circumferential furrow.

10. The shaft sealing ring as claimed in claim 4, wherein a first group of the lubricating grooves is arranged on the running surface portion on the atmosphere side.

11. The shaft sealing ring as claimed in claim 4, wherein a second group of the lubricating grooves is arranged on the running surface portion on the hydrogen side.

12. The shaft sealing ring as claimed in claim 4, wherein at least eight lubricating grooves distributed uniformly over the circumference are provided.
